(19) United States
(12) Patent Application Publication
(10) Pub. No.: US 2012/0101920 A1
(43) Pub. Date: Apr. 26, 2012

(54) APPARATUS AND METHOD FOR OPERATING PUBLIC INFRASTRUCTURE AS A MASTER LIMITED PARTNERSHIP

(75) Inventors: ROBERT B. HELLMAN, JR., Atherton, CA (US); Edward O. Diffendal, San Francisco, CA (US)

(73) Assignee: American Infrastructure MLP Fund, L.P., Foster City, CA (US)

(21) Appl. No.: 12/909,320

(22) Filed: Oct. 21, 2010

(51) Int. Cl. G06Q 40/00; G06Q 10/00

(52) U.S. Cl. 705/30

(57) ABSTRACT

A computer includes a processor and a memory. The memory stores capital data characterizing capital raised for the purchase of real property supporting public infrastructure and operating data characterizing qualifying fees collected in connection with the operation of the public infrastructure. A master limited partnership module with executable instructions executed by the processor designates master limited partnership income based upon the capital data, the operating data and terms of a public infrastructure mater limited partnership.

### CROSS-REFERENCE TO RELATED APPLICATIONS

This application is related to U.S. Ser. No. 10/306,836, filed Nov. 27, 2002, entitled “Apparatus and Method for Operating a Death-Care Business as a Master Limited Partnership”, U.S. Ser. No. 11/558,371, filed Nov. 9, 2006, entitled “Apparatus and Method for Converting Investment Capital into Publicly Traded and Private Master Limited Partnerships” and U.S. Ser. No. 12/028,741, filed Feb. 8, 2008, entitled “Apparatus and Method for Operating a Landfill Business as a Master Limited Partnership”. The content of each application is incorporated herein by reference.

### FIELD OF THE INVENTION

This invention relates generally to the funding and operation of public infrastructure. More particularly, this invention relates to a computer-implemented technique for operating public infrastructure as a master limited partnership.

### BACKGROUND OF THE INVENTION

A master limited partnership is a corporate organization governed by a contract between management (e.g., general partners) and investors (e.g., limited partners). A master limited partnership combines the tax benefits of a limited partnership with the liquidity of publicly traded securities. The master limited partnership was originally conceived as an organizational structure to capitalize on mature, low growth, cash generating businesses. Accordingly, master limited partnerships have been used in such industries as oil, gas, real estate, and natural resources.

Master limited partnerships typically carry dividend yields (e.g., 7-10%). As such, the securities generally trade on a yield basis. In the current market environment, such securities are in high demand due to their superior yield and the lower perceived risk of the stable underlying business.

In a master limited partnership, partners receive cash distributions rather than dividends. Unlike a corporation, qualifying, publicly traded master limited partnerships are not subject to federal and state income taxes. Instead, all income, gains, losses and deductions of a partnership are passed through to the partners who are required to report their allocable share on their individual tax returns. Cash distributions are generally not currently taxable as long as the partner's tax basis in the partnership interest exceeds zero.

The ideal master limited partnership is cash flow positive, but generates minimal taxable income through heavy depreciation, amortization, depletion, and the like. In a partnership, tax losses and gains are passed through to the partners, but when a partnership distributes more cash than it reports as taxable income, the cash distribution amount in excess of the partner's allocable share of income is treated as a return of capital for tax purposes. Thus, under this scenario, each time an investor receives a cash distribution, the return of capital tax treatment lowers his basis in the stock rather than creating dividend income that is taxable as ordinary income in the current period.

In view of these tax advantages, master limited partnerships are predominantly retail products sold to high net worth individuals and other tax paying entities. Most master limited partnerships generate unrelated business taxable income that prevents most institutional investors from being able to invest in master limited partnerships.

The tax advantages of master limited partnerships were greatly reduced through the Tax Reform Act of 1987. In addition, the lines of business in which tax exempt master limited partnerships can operate were greatly limited through the same tax act.

According to the Internal Revenue Code, Section 7704(d), in order for a publicly traded partnership to avoid being taxed as a corporation, it must generate more than 90% of its gross income from qualifying sources, referred to as qualifying income. Master limited partnerships can have wholly-owned taxable subsidiaries to hold the assets that generate non-qualifying income. With this structure, an entity can generate less than 90% of its income from qualifying sources and still qualify as a master limited partnership by dropping the non-qualifying assets into the taxable subsidiary. The primary disadvantage with this structure is that the subsidiary is unable to shield its income from taxes and any dividends that are routed to the master limited partnership are subject to double taxation. The master limited partnership suffers a valuation discount for every dollar of taxes paid by the taxable subsidiary.

In view of the narrowing of the scope of qualifying industries through the Tax Reform Act of 1987 and the inefficiencies outlined above in restructuring businesses that have both qualifying and non-qualifying activities, the use of master limited partnerships outside of the natural resource sector has declined. In addition, despite the Tax Reform Act of 1987 preserving the qualification relating to the sale and/or rental of real property, there have only been several instances of the MLP structure being utilized in a business conducting the sale or rental of real property. Most companies engaged in the ownership, sale and rental of real property have elected to organize under the Real Estate Investment Trust (REIT) structure.

The decline in the use of MLP structures has coincided with the decline in public infrastructure in the United States. As used herein, the term public infrastructure refers to physical structures that are accessible to the general public, such as roads, bridges, transportation terminals and water ports. Public infrastructure is typically owned by the public, but not necessarily.

Most public infrastructure is in a growing state of disrepair. Prevailing economic challenges make financing the repair or the construction of new public infrastructure difficult. Typically, such tasks are performed by government, but governments from the municipal to the federal level are facing rising constraints on spending. There has been very little private investment in public infrastructure in view of high prices, long duration to positive cash flows and lack of liquidity.

In view of the foregoing, it would be desirable to provide new funding mechanisms for public infrastructure. More particularly, it would be desirable to provide a means (via a computer-implemented technique) for public infrastructure to have a new source of financing by operating as a master limited partnership.

### SUMMARY OF THE INVENTION

The invention includes a computer with a processor and a memory. The memory stores capital data characterizing capital raised for the purchase of real property supporting public infrastructure and operating data characterizing qualifying fees collected in connection with the operation of the public infrastructure. A master limited partnership module with executable instructions executed by the processor designates master limited partnership income based upon the capital data, the operating data and terms of a public infrastructure mater limited partnership.

### BRIEF DESCRIPTION OF THE FIGURES

The invention is more fully appreciated in connection with the following detailed description taken in conjunction with the accompanying drawings, in which:

FIG. 1 illustrates a computer configured to implement operations associated with an embodiment of the invention.

FIG. 2 illustrates operations associated with an embodiment of the invention.

Like reference numerals refer to corresponding parts throughout the several views of the drawings.

### DETAILED DESCRIPTION OF THE INVENTION

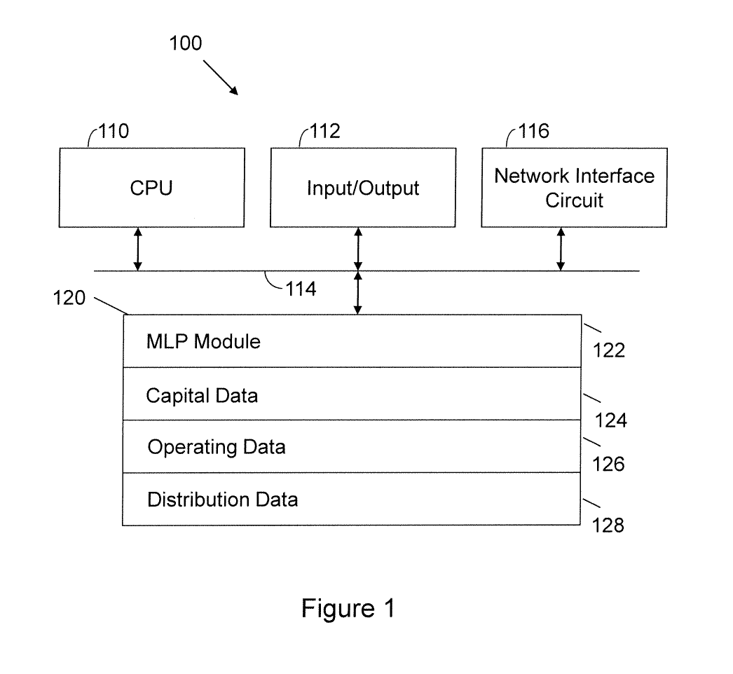

FIG. 1 illustrates a computer 100 to implement operations of the invention. The computer 100 includes standard components, such as a central processing unit 110 connected to input/output devices 112 via a bus 114. The input/output devices 112 may include a keyboard, mouse, touchpad, display, printer and the like. A network interface circuit 116 is also connected to the bus 114 and provides access to a network (not shown). Thus, the computer 100 may operate in a networked environment.

A memory 120 is also connected to the bus 114. The memory 120 includes executable instructions to implement operations associated with the invention. The memory 120 stores an MLP module 122. The MLP module 122 includes executable code defining the terms and conditions of a public infrastructure master limited partnership. The public infrastructure master limited partnership defines the relationships between the public infrastructure business managers (e.g., the general partners) and the public infrastructure business investors (e.g., the limited partners). The agreement specifies operating parameters, such as ownership interests, capital structures, investment policies, cash distribution levels, and management rights. By way of example, the executable code of the MLP module 122 may include a set of conditional (e.g., if-then-else) statements that control rights and resources in accordance with an underlying physical infrastructure master limited partnership agreement. A software engineer using well known programming techniques can prepare the executable code based upon the terms of the public infrastructure master limited partnership agreement.

The MLP module 122 accesses capital data 124 characterizing contributed capital from each investor. The MLP module 122 also accesses public infrastructure operating data 126. For example, in the case of a toll road or a toll bridge, the operating data 124 may include data on toll fees collected. In the case of a transportation terminal, the operating data 124 may include lease fees paid by transportation providers. In the case of a water port, the operating data 124 may include lease fees for access to docks.

The MLP module 122 uses the capital data 124, operating data 126 and the terms of the landfill MLP to compute distribution data 128. The distribution data 128 specifies MLP income that is distributed to partners.

The memory 120 may include additional modules, such as a regulatory report module (not shown). The regulatory report module includes executable instructions to process the data in memory and produce regulatory data. The regulatory data may include information on distributed cash. The regulatory data may be submitted to the Securities and Exchange Commission and similar regulatory bodies.

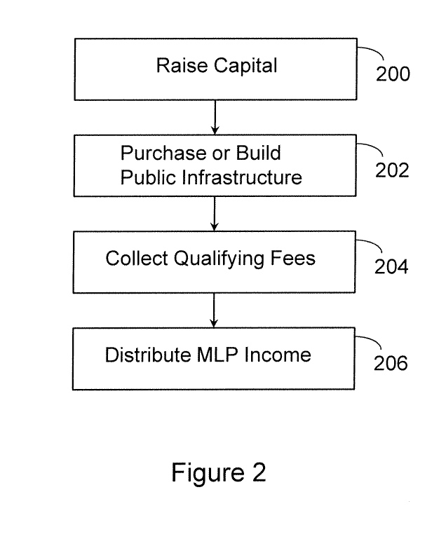

FIG. 2 illustrates processing operations associated with an embodiment of the invention. Initially, capital is raised for a public infrastructure MLP 200. The raised capital is entered into computer 100 in the form of capital data characterizing capital contributed by individual investors. Public infrastructure is then purchased or built 202. For example, an existing bridge, toll road, transportation terminal or water port may be purchased from a municipality or other government entity. Alternately, privately held land may be purchased and public infrastructure may be subsequently erected on the privately held land.

Qualifying fees are then collected. Qualifying fees are fees recognized under MLP governing law as non-taxable. For example, in the case of real estate, rent is a qualifying fee. In the case of public infrastructure, it is believed that rent in the form of a toll for access to real property is qualifying income. Other arrangement may be utilized to derive qualifying fees. For example, the owner of the public infrastructure may lease the public infrastructure to an operating company. The lease payments represent qualifying income. The lease may be in the form of a flat rental fee and/or a percentage of gross tolls collected by the operating company. The operating company needs to be unrelated to the property owner, which means the property holder may not hold greater than 10% of the ownership interests in the operating company.

The qualifying income is loaded into computer 100 in the form of operating data 126. MLP income is then distributed 206. In particular, the MLP module 122 processes the capital data, the operating data 126 and the terms of the MLP agreement to designate capital distributions.

Those skilled in the art will recognize a number of advantages associated with the invention. First, the invention provides an attractive vehicle to encourage the utilization of private capital to fund needed public infrastructure. The MLP may be taken public through a public securities offering of limited partner units. This provide liquidity for investors, which is typically not available with investments in public infrastructure. Further, a portfolio of public infrastructure projects may be assembled to generate stable and consistent cash flow that is valued higher than current corporate holding structures. Thus, the invention facilitates access to competitively priced capital.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer, comprising:
a processor; and
a memory storing
capital data characterizing capital raised for the purchase of real property supporting public infrastructure,
operating data characterizing qualifying fees collected in connection with the operation of the public infrastructure, and
a master limited partnership module with executable instructions executed by the processor to designate master limited partnership income based upon the capital data, the operating data and terms of a public infrastructure mater limited partnership.

2. The computer of claim 1, wherein the qualifying fees are in the form of tolls, which are designated as rental income of real property.

3. The computer of claim 1, wherein the qualifying fees are in the form of rental fees paid by an operating company controlling the operation of the public infrastructure.
